(19) United States
(12) Patent Application Publication
(10) Pub. No.: US 2023/0268551 A1
(43) Pub. Date: Aug. 24, 2023

(54) GEL POLYMER ELECTROLYTE FOR ELECTROCHEMICAL CELL

(71) Applicant: GM GLOBAL TECHNOLOGY OPERATIONS LLC, Detroit, MI (US)

(72) Inventors: Zhe LI, Shanghai (CN); Qili SU, Shanghai (CN); Haijing LIU, Shanghai (CN)

(73) Assignee: GM GLOBAL TECHNOLOGY OPERATIONS LLC, Detroit, MI (US)

(21) Appl. No.: 17/738,767

(22) Filed: May 6, 2022

(30) Foreign Application Priority Data
Feb. 18, 2022 (CN) 202210154174.8

(51) Int. Cl. H01M 10/0565; H01M 10/0525

(52) U.S. Cl. CPC H01M 10/0565; H01M 10/0525; H01M 2004/028; H01M 2300/0025

(57) ABSTRACT

A gel polymer electrolyte for an electrochemical cell that cycles lithium ions comprises a polymer matrix infiltrated with a liquid electrolyte solution. The polymer matrix comprises poly(vinylidene fluoride-co-hexafluoropropylene). The liquid electrolyte solution comprises a nonaqueous organic solvent, a first lithium salt in the nonaqueous organic solvent, and a second lithium salt in the nonaqueous organic solvent. The first lithium salt comprises lithium difluoro(oxalato)borate and the second lithium salt comprises lithium bis(trifluoromethanesulfonyl)imide.

### CROSS-REFERENCE TO RELATED APPLICATIONS

This application claims the benefit and priority of Chinese Application No. 202210154174.8, filed Feb. 18, 2022. The entire disclosure of the above application is incorporated herein by reference.

### INTRODUCTION

This section provides background information related to the present disclosure which is not necessarily prior art.

The present disclosure relates to electrolytes for electrochemical cells that cycle lithium ions and, more particularly, to gel polymer electrolytes that include a liquid electrolyte solution and a polymer matrix that functions as a host for the liquid electrolyte solution.

Electrochemical cells of secondary lithium batteries generally include a negative electrode, a positive electrode spaced apart from the negative electrode, and an ionically conductive electrolyte that provides a medium for the conduction of lithium ions between the negative and positive electrodes during discharge and recharge of the electrochemical cell. The ionically conductive electrolyte may be in the form of a solid, a liquid, or a hybrid of a solid and a liquid. Gel polymer electrolytes are hybrids and include a polymer matrix infiltrated with a liquid electrolyte solution, which generally comprises a lithium salt dissolved or dispersed in one or more nonaqueous aprotic organic solvents. The liquid electrolyte solution acts as a lithium ion pathway through the polymer matrix, while the polymer matrix provides the gel polymer electrolyte with mechanical stability. Electrolytes of secondary lithium batteries may be formulated to exhibit certain desirable properties over a wide operating temperature range. Such desirable properties may include high ionic conductivity, high dielectric constant (correlated with a high ability to dissolve salts), good thermal stability, a wide electrochemical stability window, ability to form a stable ionically conductive solid electrolyte interface (SEI) on the surface of the negative electrode, ability to maintain robust interfacial contact with electrode surfaces, ability to inhibit the formation of mossy or dendritic lithium on the surface of the negative electrode, and chemical compatibility with other components of the electrochemical cell.

### SUMMARY

This section provides a general summary of the disclosure and is not a comprehensive disclosure of its full scope or all of its features.

A gel polymer electrolyte for an electrochemical cell that cycles lithium ions is disclosed. The gel polymer electrolyte comprises a polymer matrix infiltrated with a nonaqueous organic solvent, a first lithium salt in the nonaqueous organic solvent, and a second lithium salt in the nonaqueous organic solvent. The polymer matrix comprises poly(vinylidene fluoride-co-hexafluoropropylene). The first lithium salt comprises lithium difluoro(oxalato)borate and the second lithium salt comprises lithium bis(trifluoromethanesulfonyl)imide.

The gel polymer electrolyte may be self-extinguishing.

The nonaqueous organic solvent may comprise a cyclic carbonate, a lactone, a nitrile, a sulfone, an ether, a phosphate, or a combination thereof.

In aspects, the nonaqueous organic solvent may comprise a mixture of a first solvent and a second solvent. The first solvent may comprise propylene carbonate and the second solvent may comprise fluoroethylene carbonate. In such case, a volumetric ratio of the first solvent to the second solvent in the nonaqueous organic solvent may be greater than or equal to about 0.5:9.5 to less than or equal to about 9.5:0.5.

A concentration of the first lithium salt in the nonaqueous organic solvent may be greater than or equal to about 0.05 moles per liter to less than or equal to about 2.0 moles per liter. A concentration of the second lithium salt in the nonaqueous organic solvent may be greater than or equal to about 0.05 moles per liter to less than or equal to about 2.0 moles per liter. A concentration of the first lithium salt in the nonaqueous organic solvent may be greater than a concentration of the second lithium salt in the nonaqueous organic solvent.

A total concentration of the first lithium salt and the second lithium salt in nonaqueous organic solvent may be greater than or equal to about 1.5 moles per liter to less than or equal to about 4.0 moles per liter.

The gel polymer electrolyte may consist essentially of the polymer matrix, the nonaqueous organic solvent, the first lithium salt, and the second lithium salt, the first lithium salt may consist essentially of lithium difluoro(oxalato)borate, and the second lithium salt may consist essentially of lithium bis(trifluoromethanesulfonyl)imide.

In combination, the nonaqueous organic solvent, the first lithium salt, and the second lithium salt may constitute, by weight, greater than or equal to about 60% to less than or equal to about 99.5% of the gel polymer electrolyte. The polymer matrix may constitute, by weight, greater than or equal to about 0.5% to less than or equal to about 40% of the gel polymer electrolyte.

The polymer matrix may further comprise poly(ethylene oxide), poly(acrylic acid), poly(methyl methacrylate), carboxymethyl cellulose, polyacrylonitrile, poly(vinyl alcohol), polyvinylpyrrolidone, or a combination thereof.

The gel polymer electrolyte may further comprise a third lithium salt. The third lithium salt may comprise lithium bis(oxalato)borate, lithium tetracyanoborate, lithium tetrafluroborate, lithium bis(monofluoromalonato)borate, lithium trifluoromethanesulfonate, lithium bis(fluorosulfonyl)imide, lithium cyclo-difluoromethane-1,1-bis(sulfonyl)imide, lithium bis(perfluoroethanesulfonyl)imide, lithium cyclo-hexafluoropropane-1,1-bis(sulfonyl)imide, or a combination thereof.

The gel polymer electrolyte may be substantially free of lithium hexafluorophosphate.

An electrochemical cell that cycles lithium ions is disclosed. The electrochemical cell comprises a positive electrode current collector, a positive electrode layer disposed on the positive electrode current collector, a negative electrode current collector, a porous separator disposed between the positive electrode layer and the negative electrode current collector, and a gel polymer electrolyte that infiltrates open pores in the positive electrode layer and in the porous separator. The positive electrode layer has a facing surface and includes electroactive material particles. The negative electrode current collector has a major surface that opposes the facing surface of the positive electrode layer. The gel polymer electrolyte comprises a polymer matrix infiltrated with a nonaqueous organic solvent, a first lithium salt in the nonaqueous organic solvent, and a second lithium salt in the nonaqueous organic solvent. The polymer matrix comprises poly(vinylidene fluoride-co-hexafluoropropylene). The first lithium salt comprises lithium difluoro(oxalato)borate. The second lithium salt comprises lithium bis(trifluoromethanesulfonyl)imide.

The nonaqueous organic solvent may comprise a mixture of propylene carbonate and fluoroethylene carbonate.

A concentration of the first lithium salt in the nonaqueous organic solvent may be greater than or equal to about 0.5 moles per liter to less than or equal to about 1.5 moles per liter. A concentration of the second lithium salt in the nonaqueous organic solvent may be greater than or equal to about 0.4 moles per liter to less than or equal to about 1.0 mole per liter. A concentration of the first lithium salt in the nonaqueous organic solvent may be greater than a concentration of the second lithium salt in the nonaqueous organic solvent.

In combination, the nonaqueous organic solvent, the first lithium salt, and the second lithium salt may constitute, by weight, greater than or equal to about 60% to less than or equal to about 99.5% of the gel polymer electrolyte. The polymer matrix may constitute, by weight, greater than or equal to about 0.5% to less than or equal to about 40% of the gel polymer electrolyte.

The electrochemical cell may further comprise a lithium metal negative electrode layer and an interfacial layer formed in situ on a facing surface of the lithium metal negative electrode layer. The lithium metal negative electrode layer may be electrochemically deposited on a major surface of the negative electrode current collector. The facing surface of the lithium metal negative electrode layer may oppose the facing surface of the positive electrode layer. The interfacial layer may extend substantially continuously along an interface between the porous separator and the facing surface of the lithium metal negative electrode layer.

The interfacial layer may comprise electrochemical reduction products of one or more components of the gel polymer electrolyte. In such case, the electrochemical reduction products may comprise a fluorine-containing oligomer, a boron-containing oligomer, lithium bis[N-(trifluoromethylsulfonylimino)] trifluoromethanesulfonate, lithium fluoride, lithium oxide, lithium sulfide, lithium dithionite, lithium sulfite, lithium nitride, or a combination thereof.

The gel polymer electrolyte may be self-extinguishing.

The gel polymer electrolyte may be substantially free of lithium hexafluorophosphate.

Another electrochemical cell that cycles lithium ions is disclosed. The electrochemical cell comprises a positive electrode current collector, a positive electrode layer disposed on a major surface of the positive electrode current collector, a negative electrode current collector, a lithium metal negative electrode layer electrochemically deposited on a major surface of the negative electrode current collector, a porous separator disposed between the positive electrode layer and the lithium metal negative electrode layer, and a gel polymer electrolyte that infiltrates open pores in the positive electrode layer and in the porous separator. The positive electrode layer includes electroactive material particles. The major surface of the negative electrode current collector opposes the major surface of the positive electrode current collector. The gel polymer electrolyte extends substantially continuously between the major surface of the positive electrode current collector and the lithium metal negative electrode layer. The gel polymer electrolyte comprises a polymer matrix infiltrated with a nonaqueous organic solvent, a first lithium salt in the nonaqueous organic solvent, and a second lithium salt in the nonaqueous organic solvent. The polymer matrix comprises poly(vinylidene fluoride-co-hexafluoropropylene). The nonaqueous organic solvent comprises a mixture of propylene carbonate and fluoroethylene carbonate. The first lithium salt comprises lithium difluoro(oxalato)borate. The second lithium salt comprises lithium bis(trifluoromethanesulfonyl)imide.

Each of the electroactive material particles in the positive electrode layer may be at least partially encased in the gel polymer electrolyte.

The gel polymer electrolyte may fill, by volume, greater than or equal to about 5% to less than or equal to about 100% of the open pores in the positive electrode layer and in the porous separator.

The porous separator may comprise a microporous polymeric membrane.

The porous separator may comprise a solid electrolyte layer. The solid electrolyte layer may include inorganic solid electrolyte material particles. The inorganic solid electrolyte material particles may be electrically insulating and ionically conductive. Each of the inorganic solid electrolyte material particles may be at least partially encased in the gel polymer electrolyte.

The lithium metal negative electrode layer may comprise, by weight, greater than or equal to about 97% lithium.

The electroactive material particles of the positive electrode layer may comprise a lithium transition-metal oxide represented by the following formula: LiMeO₂, LiMePO₄, Li₃Me₂(PO₄)₃, LiMe₂O₄, LiMeSO₄F LiMePO₄F, or a combination thereof, where Me is Co, Ni, Mn, Fe, Al, V, or a combination thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a schematic cross-sectional view of an electrochemical cell that cycles lithium ions, including a positive electrode layer disposed on a positive electrode current collector, a lithium metal negative electrode layer disposed on a negative electrode current collector, and a porous polymeric separator disposed between the positive and negative electrode layers, wherein pores of the positive electrode layer and the porous polymeric separator are infiltrated with a gel polymer electrolyte.

FIG. 2 is a schematic depiction of the electrochemical cell of FIG. 1 prior to initial charging of the electrochemical cell and prior to deposition of the lithium metal negative electrode layer on the negative electrode current collector.

FIG. 3 is a schematic cross-sectional view of another electrochemical cell that cycles lithium ions, including a positive electrode layer disposed on a positive electrode current collector, a lithium metal negative electrode layer disposed on a negative electrode current collector, and a solid electrolyte layer disposed between the positive and negative electrode layers, wherein pores of the positive electrode layer and the solid electrolyte layer are infiltrated with a gel polymer electrolyte.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature’s relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated.

The term “substantially free from” or “substantially free of” as used herein means less than about 1%, preferably less than about 0.8%, more preferably less than about 0.5%, still more preferably less than about 0.3%, most preferably about 0%, by total weight of the composition or material.

Example embodiments will now be described more fully with reference to the accompanying drawings.

The present disclosure relates to gel polymer electrolytes for electrochemical cells that cycle lithium ions and include lithium metal negative electrode layers. In aspects, the presently disclosed electrochemical cells may be described as “anode-free” due to the fact that the electrochemical cells may be initially assembled without a negative electrode layer but, during their first charge, lithium metal may be deposited on a bare negative electrode current collector without an intercalation host material, thereby forming a lithium metal negative electrode layer.

The presently disclosed gel polymer electrolytes are formulated to provide the electrochemical cells with improved cycling stability and high coulombic efficiency. For example, during initial charging of the electrochemical cells, the gel polymer electrolytes may react with lithium along surfaces of a negative electrode current collector to form robust solid electrolyte interfaces (SEI). During cycling of the electrochemical cells, the as-formed solid electrolyte interfaces may promote the electrochemical deposition of relatively smooth and dense lithium metal negative electrode layers on the negative electrode current collectors. In addition, the gel polymer electrolytes are formulated to provide the electrochemical cells with flame retardancy, for example, in aspects, the gel polymer electrolytes may be self-extinguishing and/or non-combustible.

The presently disclosed gel polymer electrolytes include a polymer matrix, a nonaqueous organic solvent, a first lithium salt dissolved or dispersed in the nonaqueous organic solvent, and a second lithium salt dissolved or dispersed in the nonaqueous organic solvent. The nonaqueous organic solvent, the first lithium salt, and the second lithium salt infiltrate the porous polymer matrix, which acts as a host for the nonaqueous organic solvent, the first lithium salt, and the second lithium salt. The polymer matrix comprises a copolymer of polyvinylidene fluoride (PVdF) and hexafluoropropylene (HFP). In aspects, the nonaqueous organic solvent may comprise a mixture of propylene carbonate (PC) and fluoroethylene carbonate (FEC). The first lithium salt may comprise lithium difluoro(oxalato)borate (LiDFOB) and the second lithium salt may comprise lithium bis(trifluoromethanesulfonyl)imide (LiTFSI). Without intending to be bound by theory, it is believed that the nonaqueous organic solvent mixture and the combination of LiDFOB and LiTFSI in the presently disclosed gel polymer electrolytes may synergistically improve the cycling stability and coulombic efficiency of electrochemical cells that include the gel polymer electrolytes, as compared to electrochemical cells with gel polymer electrolytes that primarily include lithium hexafluorophosphate (LiPF₆) as a lithium salt and/or mixtures of ethylene carbonate (EC) and diethyl carbonate (DEC) as organic solvents. The first and second lithium salts of the presently disclosed gel polymer electrolytes may, for example, promote the formation of a relatively thin stable solid electrolyte interface (SEI) on the surface of the lithium metal negative electrode layer and/or may inhibit the formation of mossy or dendritic lithium on the surface of the lithium metal negative electrode layer during repeated cycling of the electrochemical cells.

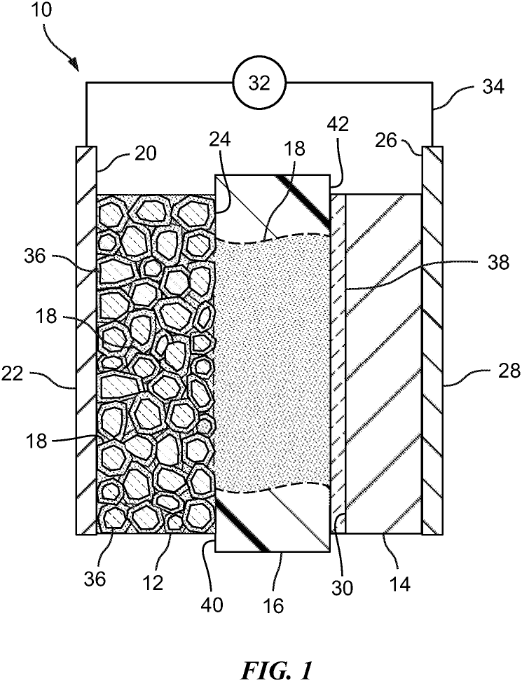

FIG. 1 depicts an electrochemical cell 10 that may be combined with one or more additional electrochemical cells to form a battery that cycles lithium ions, such as a secondary lithium metal battery. The electrochemical cell 10 includes a positive electrode layer 12, a lithium metal negative electrode layer 14, a porous separator 16 sandwiched between the positive and negative electrode layers 12, 14, and a gel polymer electrolyte 18 that provides a medium for the conduction of lithium ions between the positive electrode layer 12 and the lithium metal negative electrode layer 14, through the porous separator 16. The positive electrode layer 12 is disposed on a major surface 20 of a positive electrode current collector 22 and has a first facing surface 24 that faces toward the lithium metal negative electrode layer 14. The lithium metal negative electrode layer 14 is electrochemically deposited on a major surface 26 of a negative electrode current collector 28 and has a second facing surface 30 that faces toward the positive electrode layer 12. The porous separator 16 electrically isolates the positive and negative electrode layers 12, 14 from each other. The gel polymer electrolyte 18 infiltrates the pores of the porous separator 16 and of the positive electrode layer 12. In practice, the positive and negative electrode current collectors 22, 28 may be electrically coupled to a load and/or power source 32 via an external circuit 24.

The electrochemical cell 10 may be used in vehicle or automotive transportation applications (e.g., motorcycles, boats, tractors, buses, motorcycles, mobile homes, campers, and tanks), as well as in a wide variety of other industries and applications, including aerospace components, consumer products, devices, buildings (e.g., houses, offices, sheds, and warehouses), office equipment and furniture, and industrial equipment machinery, agricultural or farm equipment, or heavy machinery, by way of non-limiting example. In certain aspects, the electrochemical cell 10 may be used in Hybrid Electric Vehicles (HEVs) and/or Electric Vehicles (EVs).

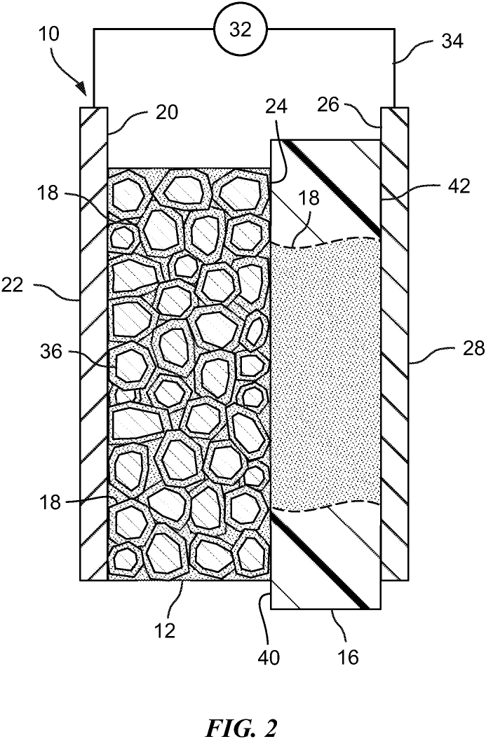

As shown in FIG. 2, the electrochemical cell 10 may be assembled without a lithium metal negative electrode layer 14. In such case, after initial assembly, the major surface 26 of the negative electrode current collector 28 will be substantially bare and in direct physical contact with the porous separator 16. When the electrochemical cell 10 is initially charged by the power source 32, lithium ions will be released from the positive electrode layer 12 and electrochemically deposited or plated on the major surface 26 of the negative electrode current collector 28, with the electrochemically deposited lithium forming the lithium metal negative electrode layer 14 in situ. When the electrochemical cell 10 is at least partially charged, an electrochemical potential difference is established between the positive and negative electrode layers 12, 14. During discharge of the electrochemical cell 10, the electrochemical potential established between the positive and negative electrode layers 12, 14 drives spontaneous redox reactions within the electrochemical cell 10 and the release of lithium ions and electrons from the lithium metal negative electrode layer 14. The released lithium ions travel from the lithium metal negative electrode layer 14 to the positive electrode layer 12 through the porous separator 16 and the gel polymer electrolyte 18. At the same time, the electrons travel from the lithium metal negative electrode layer 14 to the positive electrode layer 12 via the external circuit 34, which generates an electric current. After the lithium metal negative electrode layer 14 has been partially or fully depleted of lithium, the electrochemical cell 10 may be recharged by connecting the positive and negative electrode current collectors 22, 28 of the positive and negative electrode layers 12, 14 to the power source 32, which drives nonspontaneous redox reactions within the electrochemical cell 10 and the release of the lithium ions and the electrons from the positive electrode layer 12. The repeated charging and discharge of the electrochemical cell 10 may be referred to herein as “cycling,” with a full charge event followed by a full discharge event being considered a full cycle.

The positive electrode layer 12 may be in the form of a substantially continuous porous layer of material and may include one or more electrochemically active materials that can undergo a reversible redox reaction with lithium at a higher electrochemical potential than the electrochemically active material of the lithium metal negative electrode layer 14 such that an electrochemical potential difference exists between the positive and negative electrode layers 12, 14. For example, the positive electrode layer 12 may comprise a material that can undergo lithium intercalation and deintercalation or can undergo a conversion by reaction with lithium. In aspects, the positive electrode layer 12 may comprise an intercalation host material that can undergo the reversible insertion or intercalation of lithium ions. In such case, the intercalation host material of the positive electrode layer 12 may comprise a layered oxide represented by the formula LiMeO₂, an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In further aspects, the positive electrode layer 12 may comprise a conversion material including a component that can undergo a reversible electrochemical reaction with lithium, in which the component undergoes a phase change or a change in crystalline structure accompanied by a change in oxidation state. In such case, the conversion material of the positive electrode layer 12 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof. Examples of metals for inclusion in the conversion material of the positive electrode layer 12 include iron, manganese, nickel, copper, and cobalt. In aspects, the electrochemically active material of the positive electrode layer 12 may comprise LiCoO₂, LiMn₂O₄, LiNi_{0.5}Mn_{1.5}O₄, LiV₂(PO₄)₃, and/or LiMn_{0.7}Fe_{0.3}PO₄.

The electrochemically active material of the positive electrode layer 12 may be a particulate material and the positive electrode layer 12 may include a plurality of substantially homogenously distributed electrochemically active (electroactive) material particles 36. The electroactive material particles 36 may have a D50 diameter of greater than or equal to about 0.01 micrometers to less than or equal to about 100 micrometers. The electroactive material particles 36 may constitute, by weight, greater than or equal to about 30% to less than or equal to about 98% of the positive electrode layer 12. The electroactive material particles 36 may provide the positive electrode layer 12 with an areal capacity of greater than or equal to about 0.5 milliampere hours per square centimeter (mAh/cm²) to less than or equal to about 10 mAh/cm², or greater than or equal to about 0.5 mAh/cm² to less than or equal to about 3 mAh/cm². For example, the electroactive material particles 36 may provide the positive electrode layer 12 with an areal capacity of about one (1) mAh/cm².

In the positive electrode layer 12, the electroactive material particles 36 may be intermingled with a polymer binder (not shown) that provides the positive electrode layer 12 with structural integrity. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than 0% to less than or equal to about 20% of the positive electrode layer 12.

The positive electrode layer 12 optionally may include particles of an electrically conductive material (not shown). Examples of electrically conductive materials include carbon-based materials, metals (e.g., nickel), and/or electrically conductive polymers. Examples of electrically conductive carbon-based materials include carbon black (e.g., acetylene black), graphite, graphene (e.g., graphene nanoplatelets), graphene oxide, carbon nanotubes, and/or carbon fibers (e.g., carbon nanofibers). Examples of electrically conductive polymers include polyaniline, polythiophene, polyacetylene, and/or polypyrrole. The electrically conductive material particles may constitute, by weight, greater than 0% to less than or equal to about 30% of the positive electrode layer 12.

The positive electrode layer 12 may have a thickness of greater than or equal to about 5 micrometers to less than or equal to about 200 micrometers and a porosity in a range of from about 5% to about 40%.

The lithium metal negative electrode layer 14 may be in the form of a layer of lithium metal. In aspects, the lithium metal negative electrode layer 14 may be substantially nonporous. In aspects, the lithium metal negative electrode layer 14 may comprise a lithium metal alloy or may consist essentially of lithium (Li) metal. For example, the lithium metal negative electrode layer 14 may comprise, by weight, greater than or equal to about 97% lithium or greater than or equal to about 99% lithium. The lithium metal negative electrode layer 14 does not comprise other elements or compounds that undergo a reversible redox reaction with lithium during operation of the electrochemical cell 10. For example, the lithium metal negative electrode layer 14 does not comprise and is substantially free of an intercalation host material that is formulated to undergo the reversible insertion or intercalation of lithium ions or an alloying material that can electrochemically alloy and form compound phases with lithium. In addition, in aspects, the lithium metal negative electrode layer 14 does not comprise and is substantially free of a conversion material or an alloy material that can electrochemically alloy and form compound phases with lithium. Examples of materials that may be excluded from the lithium metal negative electrode layer 14 include carbon-based materials (e.g., graphite, activated carbon, carbon black, and graphene), silicon and silicon-based materials, tin oxide, aluminum, indium, zinc, cadmium, lead, germanium, tin, antimony, titanium oxide, lithium titanium oxide, lithium titanate, metal oxides other than lithium oxide (e.g., iron oxide, cobalt oxide, manganese oxide, copper oxide, and/or nickel oxide), metal sulfides, and metal nitrides (e.g., phosphides, sulfides, and/or nitrides or iron, manganese, nickel, copper, and/or cobalt).

When the electrochemical cell 10 is at least partially charged, the lithium metal negative electrode layer 14 may have a thickness of greater than or equal to about 5 micrometers to less than or equal to about 600 micrometers.

An interfacial layer 38 may inherently form in situ along the major surface 26 of the negative electrode current collector 28 over the lithium metal negative electrode layer 14, for example, during initial charging of the electrochemical cell 10. When the electrochemical cell 10 is at least partially charged, the interfacial layer 38 may extend substantially continuously along an interface between the porous separator 16 and the facing surface 30 of the lithium metal negative electrode layer 14. When the electrochemical cell 10 is fully discharged, the interfacial layer 38 may extend substantially continuously along an interface between the porous separator 16 and the major surface 26 of the negative electrode current collector 28. The interfacial layer 38 is electrically insulating and ionically conductive and may inherently form in situ on the facing surface 30 of the lithium metal negative electrode layer 14 during charging of the electrochemical cell 10, for example, due to the low reduction potential of the lithium metal negative electrode layer 14 (-3.04 V vs. the standard hydrogen potential), which may promote the reduction of one or more components of the gel polymer electrolyte 18. In aspects, the interfacial layer 38 may consist essentially of products of the electrochemical reduction of one or more components of the gel polymer electrolyte 18 on the surface of the lithium metal negative electrode layer 14.

Products of the electrochemical reduction of difluoro(oxalato)borate (LiDFOB) may comprise lithium oxalate (L₂C₂O₄), lithium carbonate (Li₂CO₃), lithium fluoride (LiF), boron-and/or fluorine-containing oligomers, and combinations thereof. Products of the electrochemical reduction of lithium bis(trifluoromethanesulfonyl)imide (LiTFSI) may comprise lithium bis[N-(trifluoromethylsulfonylimino)] trifluoromethanesulfonate, LiF, lithium oxide (Li₂O), lithium sulfide (Li₂S), lithium dithionite (Li₂S₂O₄), lithium sulfite (Li₂SO₃), lithium nitride (Li₃N), and combinations thereof. Therefore, in aspects, the interfacial layer 38 may comprise L₂C₂O₄, Li₂CO₃, LiF, boron- and/or fluorine-containing oligomers, lithium bis[N-(trifluoromethylsulfonylimino)] trifluoromethanesulfonate, Li₂O, Li₂S, Li₂S₂O₄, Li₂SO₃, Li₃N, or a combination thereof.

Products of the electrochemical reduction of propylene carbonate (PC) may comprise Li₂CO₃, propylene (CH₂═CH—CH₃), lithium ethylene dicarbonate (CH₂OCO₂Li)₂, and combinations thereof. Products of the electrochemical reduction of fluoroethylene carbonate (FEC) may comprise Li₂CO₃, vinyl fluoride (CHFCH₂), carbon monoxide (CO) and/or carbon dioxide (CO₂), LiF, Li₂O, fluoroethylene carbonate (FEC) oligomers, and combinations thereof. Therefore, in aspects, the interfacial layer 38 may comprise Li₂CO₃, propylene, lithium ethylene dicarbonate, Li₂CO₃, vinyl fluoride, carbon monoxide, carbon dioxide, LiF, Li₂O, fluoroethylene carbonate oligomers, or a combination thereof.

Products of the electrochemical reduction of lithium hexafluorophosphate (LiPF₆) may comprise lithium fluorophosphates of LiₓPF_{y} and/or LiₓPF_{y}O_{z}. Therefore, in aspects, the interfacial layer 38 may be substantially free of LiₓPF_{y} and/or LiₓPF_{y}O_{z}.

The interfacial layer 38 may help prevent undesirable chemical reactions from occurring between the gel polymer electrolyte 18 and the lithium metal negative electrode layer 14 after initial charging of the electrochemical cell 10. For example, after the interfacial layer 38 is formed during initial charging of the electrochemical cell 10, the interfacial layer 38 may help prevent further chemical reactions from occurring between the gel polymer electrolyte 18 and the lithium metal negative electrode layer 14 during subsequent charging of the electrochemical cell 10. Without intending to be bound by theory, it is believed that oligomeric and/or polymeric compounds in the interfacial layer 38 may provide the interfacial layer 38 with mechanical flexibility, which may allow the interfacial layer 38 to maintain its structural integrity and continuity while accommodating the volume changes experienced by the lithium metal negative electrode layer 14 during cycling of the electrochemical cell 10.

The porous separator 16 physically separates and electrically isolates the positive and negative electrode layers 12, 14 from each other while permitting lithium ions to pass therethrough. The porous separator 16 may have a first side 40 that faces toward the positive electrode layer 12 and an opposite second side 42 that faces away from the positive electrode layer 12, toward the negative electrode current collector 28. The porous separator 16 exhibits an open microporous structure and may comprise an organic and/or inorganic material that can physically separate and electrically insulate the positive and negative electrode layers 12, 14 from each other while permitting the free flow of ions therebetween. For example, the porous separator 16 may comprise a non-woven material, e.g., a manufactured sheet, web, or mat of directionally or randomly oriented fibers. As shown in FIGS. 1 and 2, as another example, the porous separator 16 may comprise a microporous membrane or film. The non-woven material and/or the microporous membrane of the porous separator 16 may comprise a polymeric material. For example, the porous separator 16 may comprise a polyolefin-based material having the general formula (CH₂CH_{R})ₙ, where R is an alkyl group. In aspects, the porous separator 16 may comprise a single polyolefin or a combination of polyolefins. Examples of polyolefins include polyethylene (PE), polypropylene (PP), polyamide (PA), poly(tetrafluoroethylene) (PTFE), polyvinylidene fluoride (PVdF), poly(vinyl chloride) (PVC), and/or polyacetylene. Examples of other polymeric materials that may be included in or used to form the porous separator 16 include cellulose, polyimide, copolymers of polyolefins and polyimides, poly(lithium 4-styrenesulfonate)-coated polyethylene, polyetherimide (PEI), bisphenol-acetone diphthalic anhydride (BPADA), para-phenylenediamine, poly(m-phenylene isophthalamide) (PMIA), and/or expanded polytetrafluoroethylene reinforced polyvinylidenefluoride-hexafluoropropylene. In one form, the porous separator 16 may comprise a laminate of two, three, or more layers of microporous polymeric materials, e.g., a laminate of PP-PE or a laminate of PP-PE-PP. In one form, the porous separator 16 may comprise a nanofibrous sandwich structure of PVdF-PMIA-PVdF.

The porous separator 16 may have a thickness of greater than or equal to about 5 micrometers to less than or equal to about 30 micrometers and a porosity of greater than or equal to about 25% to less than or equal to about 75%.

The porous separator 16 may include a ceramic coating layer and/or a heat-resistant material coating. The ceramic coating layer and/or the heat-resistant material coating may be disposed on the first side 40 and/or the second side 42 of the porous separator 16. The ceramic coating layer may comprise alumina (Al₂O₃) and/or silica (SiO₂). The heat-resistant material coating may comprise Nomex® and/or Aramid.

The gel polymer electrolyte 18 provides a medium for the conduction of lithium ions through the electrochemical cell 10 between the positive and negative electrode layers 12, 14. In addition, the gel polymer electrolyte 18 may provide the electrochemical cell 10 with certain beneficial attributes, for example, including flame retardancy, self-extinguishing capabilities, and/or non-combustibility. The term “self-extinguishing” means that, in situations where the gel polymer electrolyte 18 is directly exposed to a flame, the gel polymer electrolyte 18 will extinguish itself within seconds or will extinguish itself immediately after the flame is removed from the gel polymer electrolyte 18.

The gel polymer electrolyte 18 infiltrates the open pores of the positive electrode layer 12 and the porous separator 16. The gel polymer electrolyte 18 may fill, by volume, greater than or equal to about 5% to less than or equal to about 100% of the open pores in the positive electrode layer 12 and/or in the porous separator 16. The gel polymer electrolyte 18 may constitute, by weight, greater than or equal to about 0% to less than or equal to about 50% of the positive electrode layer 12 and/or of the porous separator 16. In aspects, the gel polymer electrolyte 18 may constitute, by weight, greater than or equal to about 5% to less than or equal to about 30% of the positive electrode layer 12 and/or of the porous separator 16. Prior to initial charging of the electrochemical cell 10, the gel polymer electrolyte 18 is in direct physical contact with and wets the major surface 26 of the negative electrode current collector 28. After initial charging of the electrochemical cell 10 and formation of the interfacial layer 38, the gel polymer electrolyte 18 is in direct physical contact with and wets a facing surface of the interfacial layer 38. As shown in FIGS. 1 and 2, in aspects, each of the electroactive material particles 36 in the positive electrode layer 12 may be at least partially encased in the gel polymer electrolyte 18 such that the gel polymer electrolyte 18 wets an exterior surface of each of the electroactive material particles 36 in the positive electrode layer 12.

The gel polymer electrolyte 18 comprises a polymer matrix, an organic solvent, a first lithium salt dissolved in the organic solvent, and a second lithium salt dissolved in the organic solvent. The polymer matrix may constitute, by weight, greater than or equal to about 0.5% to less than or equal to about 40% of the gel polymer electrolyte 18. In combination, the organic solvent, the first lithium salt, and the second lithium salt may constitute, by weight, greater than or equal to about 60% to less than or equal to about 99.5% of the gel polymer electrolyte 18,

In aspects, the polymer matrix may constitute, by weight, about 5% of the gel polymer electrolyte 18 and the organic solvent, the first lithium salt, and the second lithium salt may, in combination, constitute, by weight, about 95% of the gel polymer electrolyte 18 and.

The organic solvent is formulated to provide the first and second lithium salts with good solubility therein and may provide the gel polymer electrolyte 18 with exceptional thermal stability (e.g., flame retardancy, self-extinguishing capabilities, and/or non-combustibility). The organic solvent may comprise a nonaqueous aprotic organic solvent or a mixture of nonaqueous aprotic organic solvents. Examples of nonaqueous aprotic organic solvents include alkyl carbonates, for example, cyclic carbonates (e.g., ethylene carbonate (EC), propylene carbonate (PC), butylene carbonate (BC), fluoroethylene carbonate (FEC), vinylene carbonate(VC), glycerol carbonate (GC), and/or 1,2-Butylene carbonate) and/or linear carbonates (e.g., dimethyl carbonate (DMC), diethyl carbonate (DEC), and/or ethylmethylcarbonate (EMC)); aliphatic carboxylic esters (e.g., methyl formate, methyl acetate, and/or methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof.

In aspects, the organic solvent may comprise a mixture of a first nonaqueous aprotic organic solvent and a second nonaqueous aprotic organic solvent. In such case, a volumetric ratio of the first nonaqueous aprotic organic solvent to the second nonaqueous aprotic organic solvent may be greater than or equal to about 0.5:9.5 to less than or equal to about 9.5:0.5. For example, in aspects, a volumetric ratio of the first nonaqueous aprotic organic solvent to the second nonaqueous aprotic organic solvent may be about 9:1. In aspects, the first organic solvent may comprise propylene carbonate and the second organic solvent may comprise fluoroethylene carbonate. For example, in aspects, the organic solvent may comprise a mixture of propylene carbonate and fluoroethylene carbonate, wherein a ratio of propylene carbonate to fluoroethylene carbonate in the organic solvent may be greater than or equal to about 0.5:9.5 to less than or equal to about 9.5:0.5, or about 9:1.

The first lithium salt and the second lithium salt may be selected to provide the gel polymer electrolyte 18 with high ionic conductivity. During initial charging of the electrochemical cell 10, the first lithium salt and the second lithium salt may participate in beneficial redox reactions with lithium to help form the interfacial layer 38 on the facing surface 30 of the lithium metal negative electrode layer 14. During repeated charging cycles of the electrochemical cell 10, the first lithium salt and the second lithium salt may promote the deposition of a relatively smooth, dendrite-free lithium metal negative electrode layer 14, which may provide the electrochemical cell 10 with high Coulombic efficiency and excellent cycling stability. In aspects, the first lithium salt may comprise lithium difluoro(oxalato)borate (LiDFOB) and the second lithium salt may comprise lithium bis(trifluoromethanesulfonyl)imide (LiTFSI).

The first lithium salt may be present in the organic solvent at a concentration of greater than or equal to about 0.05 moles per liter (mol/L, Molar, or M) to less than or equal to about 2.0 moles per liter. For example, the first lithium salt may be present in the organic solvent at a concentration of greater than or equal to about 0.5 moles per liter to less than or equal to about 1.5 moles per liter. In aspects, a concentration of the first lithium salt in the organic solvent may be about 1.0 moles per liter. The second lithium salt may be present in the organic solvent at a concentration of greater than or equal to about 0.05 moles per liter to less than or equal to about 2.0 moles per liter. For example, the second lithium salt may be present in the organic solvent at a concentration of greater than or equal to about 0.4 moles per liter to less than or equal to about 1.0 moles per liter. In aspects, a concentration of the second lithium salt in the organic solvent may be about 0.7 moles per liter. The concentration of the first lithium salt in the organic solvent may be greater than that of the second lithium salt. The total concentration of the first lithium salt and the second lithium salt in the organic solvent may be greater than or equal to about 1.5 moles per liter to less than or equal to about 4.0 moles per liter. For example, the total concentration of the first lithium salt and the second lithium salt in the organic solvent may be greater than or equal to about 1.0 moles per liter to less than or equal to about 2.5 moles per liter.

The gel polymer electrolyte 18 optionally may include one or more supplemental lithium salts dissolved in the organic solvent, in addition to the first lithium salt and the second lithium salt. Examples of supplemental lithium salts include: lithium bis(oxalato)borate, LiB(C₂O₄)₂ (LiBOB); lithium tetracyanoborate, Li(B(CN₄) (LiTCB); lithium tetrafluoroborate, LiBF₄; lithium bis(monofluoromalonato)borate (LiBFMB); lithium trifluoromethanesulfonate, LiCF₃SO₃); lithium bis(fluorosulfonyl)imide, LiN(FSO₂)₂ (LiSFI); lithium cyclo-difluoromethane-1,1-bis(sulfonyl)imide (LiDMSI); lithium bis(trifluoromethane)sulfonylimide, LiN(CF₃SO₂)₂; lithium bis(perfluoroethanesulfonyl)imide, LiN(C₂F₅SO₂)₂; lithium cyclo-hexafluoropropane-1,1-bis(sulfonyl)imide (LiHPSI); and combinations thereof. In aspects, at least a portion of the first lithium salt may be replaced by one or more of the following supplemental lithium salts: lithium bis(oxalato)borate, LiB(C₂O₄)₂ (LiBOB); lithium tetracyanoborate, Li(B(CN₄) (LiTCB); lithium tetrafluoroborate, LiBF₄; and/or lithium bis(monofluoromalonato)borate (LiBFMB). In aspects, at least a portion of the second lithium salt may be replaced by one or more of the following supplemental lithium salts: lithium trifluoromethanesulfonate, LiCF₃SO₃); lithium bis(fluorosulfonyl)imide, LiN(FSO₂)₂ (LiSFI); lithium cyclo-difluoromethane-1,1-bis(sulfonyl)imide (LiDMSI); lithium bis(trifluoromethane)sulfonylimide, LiN(CF₃SO₂)₂; lithium bis(perfluoroethanesulfonyl)imide, LiN(C₂F₅SO₂)₂; and/or lithium cyclo-hexafluoropropane-1,1-bis(sulfonyl)imide (LiHPSI).

The total concentration of the first lithium salt, the second lithium salt, and the optional one or more supplemental lithium salts in the organic solvent may be greater than or equal to about 1.5 moles per liter to less than or equal to about 4.0 moles per liter. In aspects where the gel polymer electrolyte 18 includes one or more supplemental lithium salts in addition to the first lithium salt and the second lithium salt, the first and second lithium salts may, taken together, account for greater than 50 mol. % of the lithium salt concentration in the gel polymer electrolyte 18.

In aspects, the gel polymer electrolyte 18 may be substantially free of lithium hexafluorophosphate (LiPF₆) and may be substantially free of phosphonate moieties. Unlike electrochemical cells that include LiPF₆ as the primary lithium salt in their electrolytes, the combination of LiDFOB and LiTFSI as the primary lithium salts in the gel polymer electrolyte 18 avoids the formation of lithium dendrites on the surface of the lithium metal negative electrode layer 14 and does not result in the generation of hydrogen fluoride (HF) within the gel polymer electrolyte 18 during cycling of the electrochemical cell 10.

The polymer matrix acts as a host for the organic solvent, the first lithium salt, and the second lithium salt. The polymer matrix may provide the gel polymer electrolyte 18 with structural integrity and may help ensure good physical contact between the gel polymer electrolyte 18 and the positive electrode layer 12, the porous separator 16, and the negative electrode current collector 28 or the interfacial layer 38. The polymer matrix comprises a copolymer of poly(vinylidene fluoride) and hexafluoropropylene, also referred to as poly(vinylidene fluoride-co-hexafluoropropylene) (PVDF-HFP). The polymer matrix optionally may comprise one or more additional polymers of poly(ethylene oxide) (PEO), poly(acrylic acid) (PAA), poly(methyl methacrylate) (PMMA), carboxymethyl cellulose (CMC), polyacrylonitrile (PAN), polyvinylidene difluoride (PVDF), poly(vinyl alcohol) (PVA), and/or polyvinylpyrrolidone (PVP).

The positive and negative electrode current collectors 22, 28 are electrically conductive and provide an electrical connection between the external circuit 34 and their respective positive and negative electrode layers 12, 14. In aspects, the positive and negative electrode current collectors 22, 28 may be in the form of nonporous metal foils, perforated metal foils, or a combination thereof. The negative electrode current collector 28 may be made of copper, nickel, or alloys thereof, stainless steel, or other appropriate electrically conductive material. The positive electrode current collector 22 may be made of aluminum or another appropriate electrically conductive material.

The gel polymer electrolyte 18 may be introduced into the electrochemical cell 10 and into the open pores of the positive electrode layer 12 and the porous separator 16 in the form of a precursor. The precursor may include all the components of the gel polymer electrolyte 18 (e.g., polymer matrix, the organic solvent, the first lithium salt, the second lithium salt, and optionally one or more supplemental lithium salts), as well as a volatile carrier. The volatile carrier may be a solvent that can be removed from the precursor and may be included in the precursor to decrease the viscosity of the components of the gel polymer electrolyte 18, which may allow the gel polymer electrolyte 18 to be more readily and effectively introduced into the electrochemical cell 10 and into the open pores of the positive electrode layer 12 and the porous separator 16 during assembly of the electrochemical cell 10. After the precursor is introduced into the electrochemical cell 10 and into the open pores of the positive electrode layer 12 and the porous separator 16, the volatile carrier is removed from the precursor during manufacture, leaving behind the gel polymer electrolyte 18. Thus, the volatile carrier may be a solvent having a relatively low-boiling point. For example, the volatile carrier may comprise a solvent having a boiling point less than or equal to about 150° C., and in certain aspects, optionally less than or equal to about 100° C. In aspects, the volatile carrier may consist essentially of a solvent having a relatively low-boiling point. Examples of solvents for the volatile carrier include dimethyl carbonate (DMC), ethylene carbonate, ethyl acetate, acetonitrile, acetone, toluene, propylene carbonate, diethyl carbonate, 1,2,2-tetrafluoroethyl, 2,2,3,3-tetrafluoropropyl ether, dimethyl formamide, dimethyl sulfoxide, and combinations thereof.

After removal of the volatile carrier, the electrochemical cell 10 may be free of liquid electrolytes and only contain solid-state and/or semi-solid or gel electrolytes. While the organic solvent, the first lithium salt, and the second lithium salt of the gel polymer electrolyte 18 may be in the form of a liquid, e.g., a liquid electrolyte solution, when introduced into the polymer matrix, this liquid electrolyte solution is imbibed into and interacts with the polymeric matrix, for example, by bonding with the polymeric matrix via Van der Waals forces, and the like. Thus, after the polymer matrix is infiltrated with the liquid electrolyte solution (including the organic solvent, the first lithium salt, and the second lithium salt) the liquid electrolyte solution becomes bound to the polymer matrix and no longer flows, thus serving as part of the gel polymer electrolyte 18 through the bonding with the surrounding polymer matrix. As a result, the gel polymer electrolyte 18 that remains in the electrochemical cell 10 and in the open pores of the positive electrode layer 12 and the porous separator 16 after removal of the volatile carrier exhibits a non-flowing property, in contrast to conventional liquid electrolytes that flow within pores of conventional separators and electrodes. Replacing a conventional liquid electrolyte with the presently disclosed non-flammable gel polymer electrolyte 18 that does not flow greatly enhances the thermal stability of the electrochemical cell 10 provided in accordance with certain aspects of the present disclosure.

The electrochemical cells 10 prepared in accordance with certain aspects of the present disclosure may be substantially free of flowing liquid electrolytes and may only contain solid-state and/or semi-solid or gel polymer electrolytes, such as the gel polymer electrolyte 18. In this manner, the present disclosure provides several non-limiting advantages, including reducing or eliminating a risk of electrolyte leakage by using the gel polymer electrolyte 18, instead of a traditional flowing liquid electrolyte, increased thermal stability over flowable liquid electrolyte, and/or improved electrochemical performance over solid electrolyte particles alone (e.g., due to decreased contact resistance).

In aspects, the electrochemical cell 10 may, in some instances, include another electrolyte in addition to the gel polymer electrolyte 18, and this additional electrolyte may be in solid, liquid, or gel polymer form and capable of conducting lithium ions between the positive electrode layer 12 and the lithium metal negative electrode layer 14. In certain aspects, the electrochemical cell 10 is substantially free of flowing liquid electrolyte to provide the performance advantages discussed above.

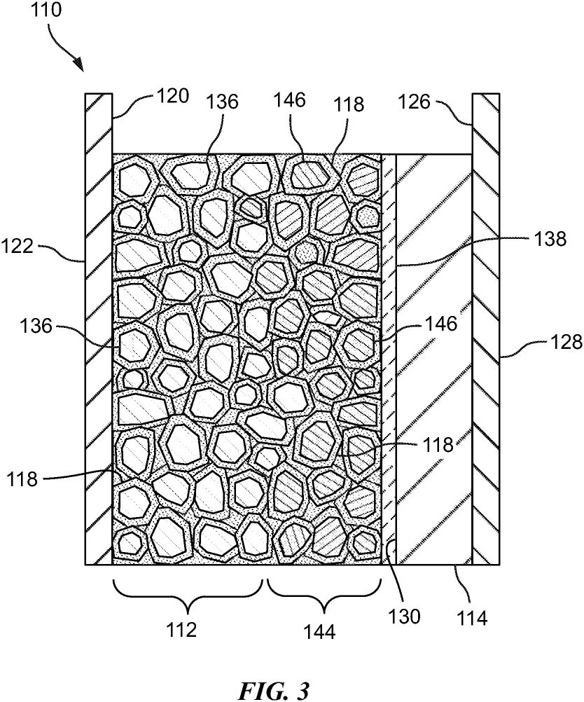

FIG. 3 depicts an electrochemical cell 110 that may be combined with one or more additional electrochemical cells to form a battery that cycles lithium ions, such as a secondary lithium metal battery. The electrochemical cell 110 is similar in many respects to the electrochemical cell 10 depicted in FIGS. 1 and 2, and a description of common subject matter generally may not be repeated here. As shown in FIG. 3, the electrochemical cell 110 includes a positive electrode layer 112, a lithium metal negative electrode layer 114, a porous separator in the form of a solid electrolyte layer 144 disposed between the positive and negative electrode layers 112, 114, and a gel polymer electrolyte 118 that infiltrates the positive electrode layer 112 and the solid electrolyte layer 144. The positive electrode layer 112 is disposed on a major surface 120 of a positive electrode current collector 122. The lithium metal negative electrode layer 114 is disposed on a major surface 126 of a negative electrode current collector 128 and has a facing surface 130 that faces toward the positive electrode layer 112.

Like the electrochemical cell 10, the electrochemical cell 110 may be assembled without a lithium metal negative electrode layer 114. In such case, when the electrochemical cell 110 is initially charged, lithium ions will be released from the positive electrode layer 112 and electrochemically deposit on the major surface 126 of the negative electrode current collector 128, with the electrochemically deposited lithium forming the lithium metal negative electrode layer 114 in situ. In addition, during initial charging of the electrochemical cell 110, an interfacial layer 138 may inherently form in situ along the major surface 126 of the negative electrode current collector 128 over the lithium metal negative electrode layer 114.

Like the positive electrode layer 12, the positive electrode layer 112 may be in the form of a substantially continuous porous layer that includes a plurality of electrochemically active (electroactive) material particles 136 and optionally a polymer binder and/or electrically conductive material particles (not shown). The electroactive material particles 136 of the positive electrode layer 112 may be made of the same electrochemically active material(s) as that of the positive electrode layer 12 and may be included in the positive electrode layer 112 in substantially the same amounts.

The solid electrolyte layer 144 electrically isolates the positive and negative electrode layers 112, 114 from each other and provides a medium for the conduction of lithium ions between the positive electrode layer 112 and the lithium metal negative electrode layer 114. In other words, the solid electrolyte layer 144 functions as both an ionically conductive electrolyte and an electrically insulating separator, and thus may eliminate the need for a discreate separator, like the separator 16.

The solid electrolyte layer 144 may be in the form of a substantially continuous porous layer including a plurality of solid electrolyte material particles 146. The solid electrolyte material particles 146 may comprise an electrically insulating and ionically conductive inorganic solid electrolyte material, e.g., a metal oxide-based material, a sulfide-based material, a nitride-based material, a hydride-based material, a halide-based material, and/or a borate-based material. Examples of metal oxide-based solid electrolyte materials include NASICON-type solid electrolyte materials (e.g., Li_{1.4}Al_{0.4}Ti_{1.6}(PO₄)₃), LISICON-type solid electrolyte materials (e.g., Li₂₊₂ₓZn₁₋ₓ GeO₄), perovskite-type solid electrolyte materials (e.g., Li₃ₓLa_{⅔-} ₓTiO₃), garnet-type solid electrolyte materials (e.g., Li₇La₃Zr₂O₁₂), and/or metal-doped or aliovalent-substituted metal oxide-based solid electrolyte materials (e.g., Al- or Nb-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, and/or Al-substituted perovskite, Li_{1+x+y}AlₓTi₂₋ₓSi_{y}P_{3-y}O_{12.}). Examples of sulfide-based solid electrolyte materials include: argyrodite materials represented by the formula Li₆PS₅X, where X = Cl, Br, I; lithium phosphorus sulfide materials represented by one or more of the following formulas Li₃PS₄, Li_{9.6}P₃S₁₂, and/or Li₇P₃S₁₁; LGPS-type materials represented by the formula Li₁₁₋ₓM₂₋ₓP₁₊ₓS₁₂, where M = Ge, Sn, Si (e.g., Li₁₀GeP₂S₁₂, Li₉P₃S₉O₃,Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, and/or Li₁₀(Si_{0.5}Sn_{0.5})P₂S₁₂); Li₂S—P₂S₅—type materials; Li₂S—P₂S₅—MOₓ—type materials; Li₂S—P₂S₅—MSₓ—type materials; thio-LISICON-type materials (e.g., Li_{3.25}Ge_{0.25}P_{0.75}S₄); Li_{3.4}Si_{0.4}P_{0.6}S₄; Li₁₀GeP₂S_{11.7}O_{0.3}; Li_{9.54}Si_{1.74}P_{1.44}S₁₁.₇Cl_{0.3}; Li_{3.833}Sn_{0.833}As_{0.166}S₄; LiI—Li₄SnS₄; and/or Li₄SnS₄. Examples of nitride-based solid electrolyte materials include: Li₃N, Li₇PN₄, and/or LiSi₂N₃. Examples of hydride-based solid electrolyte materials include: LiBH₄, LiBH₄—LiX, where X = Cl, Br or I, LiNH₂, Li₂NH, LiBH₄—LiNH₂, and/or Li₃AlH₆. Examples of halide-based solid electrolyte materials include: LiI, Li₃InCl₆, Li₂CdCl₄, Li₂MgCl₄, Li₂CdI₄, Li₂ZnI₄, and/or Li₃OCl. Examples of borate-based solid electrolyte materials include: Li₂B₄O₇ and/or Li₂O—B₂O₃—P₂O₅.

The solid electrolyte material particles 146 may have a D50 diameter of greater than or equal to about 0.01 micrometers to less than or equal to about 50 micrometers. The solid electrolyte material particles 146 may constitute, by weight, greater than or equal to about 30% to less than or equal to about 98% of the solid electrolyte layer 144. The solid electrolyte layer 144 may have a thickness of greater than or equal to about 5 micrometers to less than or equal to about 50 micrometers and a porosity in a range of from about 5% to about 50%.

In aspects, the positive electrode layer 112 may include one or more solid electrolyte material particles 146. In such case, the solid electrolyte material particles 146 may constitute, by weight, greater than 0% to less than or equal to about 50% of the positive electrode layer 112.

The gel polymer electrolyte 118 infiltrates the open pores of the positive electrode layer 112 and the open pores of the solid electrolyte layer 144. For example, the gel polymer electrolyte 18 may fill, by volume, greater than about 5% to about 100% of the open pores of the positive electrode layer 112 and/or the solid electrolyte layer 144. Prior to initial charging of the electrochemical cell 110, the gel polymer electrolyte 118 is in direct physical contact with and wets the major surface 126 of the negative electrode current collector 128. After initial charging of the electrochemical cell 110 and formation of the lithium metal negative electrode layer 114 and the interfacial layer 138, the gel polymer electrolyte 118 is in direct physical contact with and wets a facing surface of the interfacial layer 138. As shown in FIG. 3, in aspects, each of the electroactive material particles 136 in the positive electrode layer 112 and/or each of the solid electrolyte material particles 146 in the solid electrolyte layer 144 may be at least partially encased in the gel polymer electrolyte 118 such that the gel polymer electrolyte 118 wets an exterior surface of each of the electroactive material particles 136 and/or each of the solid electrolyte material particles 146.

The foregoing description of the embodiments has been provided for purposes of illustration and description. It is not intended to be exhaustive or to limit the disclosure. Individual elements or features of a particular embodiment are generally not limited to that embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A gel polymer electrolyte for an electrochemical cell that cycles lithium ions, the gel polymer electrolyte comprising:
a polymer matrix infiltrated with a nonaqueous organic solvent, a first lithium salt in the nonaqueous organic solvent, and a second lithium salt in the nonaqueous organic solvent,
wherein the polymer matrix comprises poly(vinylidene fluoride-co-hexafluoropropylene), the first lithium salt comprises lithium difluoro(oxalato)borate, and the second lithium salt comprises lithium bis(trifluoromethanesulfonyl)imide.

2. The gel polymer electrolyte of claim 1, wherein the gel polymer electrolyte is self-extinguishing.

3. The gel polymer electrolyte of claim 1, wherein the nonaqueous organic solvent comprises a mixture of a first solvent and a second solvent, the first solvent comprises propylene carbonate, the second solvent comprises fluoroethylene carbonate, and wherein a volumetric ratio of the first solvent to the second solvent in the nonaqueous organic solvent is greater than or equal to about 0.5:9.5 to less than or equal to about 9.5:0.5.

4. The gel polymer electrolyte of claim 1, wherein a concentration of the first lithium salt in the nonaqueous organic solvent is greater than or equal to about 0.05 moles per liter to less than or equal to about 2.0 moles per liter, wherein a concentration of the second lithium salt in the nonaqueous organic solvent is greater than or equal to about 0.05 moles per liter to less than or equal to about 2.0 moles per liter, wherein a concentration of the first lithium salt in the nonaqueous organic solvent is greater than a concentration of the second lithium salt in the nonaqueous organic solvent, and wherein a total concentration of the first lithium salt and the second lithium salt in the nonaqueous organic solvent is greater than or equal to about 1.5 moles per liter to less than or equal to about 4.0 moles per liter.

5. The gel polymer electrolyte of claim 1, wherein the gel polymer electrolyte consists essentially of the polymer matrix, the nonaqueous organic solvent, the first lithium salt, and the second lithium salt, and wherein the first lithium salt consists essentially of lithium difluoro(oxalato)borate, and the second lithium salt consists essentially of lithium bis(trifluoromethanesulfonyl)imide.

6. The gel polymer electrolyte of claim 1, wherein, in combination, the nonaqueous organic solvent, the first lithium salt, and the second lithium salt constitute, by weight, greater than or equal to about 60% to less than or equal to about 99.5% of the gel polymer electrolyte, and wherein the polymer matrix constitutes, by weight, greater than or equal to about 0.5% to less than or equal to about 40% of the gel polymer electrolyte.

7. The gel polymer electrolyte of claim 1, wherein the polymer matrix further comprises poly(ethylene oxide), poly(acrylic acid), poly(methyl methacrylate), carboxymethyl cellulose, polyacrylonitrile, poly(vinyl alcohol), polyvinylpyrrolidone, or a combination thereof.

8. The gel polymer electrolyte of claim 1, wherein the gel polymer electrolyte further comprises a third lithium salt, and wherein the third lithium salt comprises lithium bis(oxalato)borate, lithium tetracyanoborate, lithium tetrafluroborate, lithium bis(monofluoromalonato)borate, lithium trifluoromethanesulfonate, lithium bis(fluorosulfonyl)imide, lithium cyclo-difluoromethane-1,1-bis(sulfonyl)imide, lithium bis(perfluoroethanesulfonyl)imide, lithium cyclo-hexafluoropropane-1,1-bis(sulfonyl)imide, or a combination thereof.

9. The gel polymer electrolyte of claim 1, wherein the gel polymer electrolyte is substantially free of lithium hexafluorophosphate.

10. An electrochemical cell that cycles lithium ions, the electrochemical cell comprising:
a positive electrode current collector;
a positive electrode layer disposed on the positive electrode current collector, the positive electrode layer having a facing surface and including electroactive material particles;
a negative electrode current collector having a major surface, the major surface of the negative electrode current collector opposing the facing surface of the positive electrode layer;
a porous separator disposed between the positive electrode layer and the negative electrode current collector; and
a gel polymer electrolyte that infiltrates open pores in the positive electrode layer and in the porous separator,
wherein the gel polymer electrolyte comprises a polymer matrix infiltrated with a nonaqueous organic solvent, a first lithium salt in the nonaqueous organic solvent, and a second lithium salt in the nonaqueous organic solvent,
wherein the polymer matrix comprises poly(vinylidene fluoride-co-hexafluoropropylene), the first lithium salt comprises lithium difluoro(oxalato)borate, and the second lithium salt comprises lithium bis(trifluoromethanesulfonyl)imide.

11. The electrochemical cell of claim 10, wherein the nonaqueous organic solvent comprises a mixture of propylene carbonate and fluoroethylene carbonate, a concentration of the first lithium salt in the nonaqueous organic solvent is greater than or equal to about 0.5 moles per liter to less than or equal to about 1.5 moles per liter, a concentration of the second lithium salt in the nonaqueous organic solvent is greater than or equal to about 0.4 moles per liter to less than or equal to about 1.0 mole per liter, and a concentration of the first lithium salt in the nonaqueous organic solvent is greater than a concentration of the second lithium salt in the nonaqueous organic solvent.

12. The electrochemical cell of claim 10, wherein, in combination, the nonaqueous organic solvent, the first lithium salt, and the second lithium salt constitute, by weight, greater than or equal to about 60% to less than or equal to about 99.5% of the gel polymer electrolyte, and wherein the polymer matrix constitutes, by weight, greater than or equal to about 0.5% to less than or equal to about 40% of the gel polymer electrolyte.

13. The electrochemical cell of claim 10, further comprising:
a lithium metal negative electrode layer electrochemically deposited on the major surface of the negative electrode current collector, the lithium metal negative electrode layer having a facing surface that opposes the facing surface of the positive electrode layer; and
an interfacial layer formed in situ on the facing surface of the lithium metal negative electrode layer, the interfacial layer extending substantially continuously along an interface between the porous separator and the facing surface of the lithium metal negative electrode layer,
wherein the interfacial layer comprises electrochemical reduction products of one or more components of the gel polymer electrolyte, and wherein the electrochemical reduction products comprise a fluorine-containing oligomer, a boron-containing oligomer, lithium bis[N-(trifluoromethylsulfonylimino)] trifluoromethanesulfonate, lithium fluoride, lithium oxide, lithium sulfide, lithium dithionite, lithium sulfite, lithium nitride, or a combination thereof.

14. The electrochemical cell of claim 10, wherein the gel polymer electrolyte is self-extinguishing, and wherein the gel polymer electrolyte is substantially free of lithium hexafluorophosphate.

15. An electrochemical cell that cycles lithium ions, the electrochemical cell comprising:
a positive electrode current collector having a major surface;
a positive electrode layer disposed on the major surface of the positive electrode current collector, the positive electrode layer including electroactive material particles;
a negative electrode current collector having a major surface, the major surface of the negative electrode current collector opposing the major surface of the positive electrode current collector;
a lithium metal negative electrode layer electrochemically deposited on the major surface of the negative electrode current collector;
a porous separator disposed between the positive electrode layer and the lithium metal negative electrode layer; and
a gel polymer electrolyte that infiltrates open pores in the positive electrode layer and in the porous separator and extends substantially continuously between the major surface of the positive electrode current collector and the lithium metal negative electrode layer,
wherein the gel polymer electrolyte comprises a polymer matrix infiltrated with a nonaqueous organic solvent, a first lithium salt in the nonaqueous organic solvent, and a second lithium salt in the nonaqueous organic solvent,
wherein the polymer matrix comprises poly(vinylidene fluoride-co-hexafluoropropylene), the nonaqueous organic solvent comprises a mixture of propylene carbonate and fluoroethylene carbonate, the first lithium salt comprises lithium difluoro(oxalato)borate, and the second lithium salt comprises lithium bis(trifluoromethanesulfonyl)imide.

16. The electrochemical cell of claim 15, wherein each of the electroactive material particles in the positive electrode layer is at least partially encased in the gel polymer electrolyte.

17. The electrochemical cell of claim 15, wherein the gel polymer electrolyte fills, by volume, greater than or equal to about 5% to less than or equal to about 100% of the open pores in the positive electrode layer and in the porous separator.

18. The electrochemical cell of claim 15, wherein the porous separator comprises a microporous polymeric membrane.

19. The electrochemical cell of claim 15, wherein the porous separator comprises a solid electrolyte layer that includes inorganic solid electrolyte material particles, the inorganic solid electrolyte material particles are electrically insulating and ionically conductive, and wherein each of the inorganic solid electrolyte material particles is at least partially encased in the gel polymer electrolyte.

20. The electrochemical cell of claim 15, wherein the lithium metal negative electrode layer comprises, by weight, greater than or equal to about 97% lithium, and wherein the electroactive material particles of the positive electrode layer comprise a lithium transition-metal oxide represented by the following formula: LiMeO₂, LiMePO₄, Li₃Me₂(PO₄)₃, LiMe2O₄, LiMeSO₄F LiMePO₄F, or a combination thereof, where Me is Co, Ni, Mn, Fe, Al, V, or a combination thereof.
